(19) United States
(12) Patent Application Publication
(10) Pub. No.: US 2014/0297549 A1
(43) Pub. Date: Oct. 2, 2014

(54) SYSTEM FOR EXCHANGING JOBS AND TRIP INFORMATION TO REDUCE DRIVING AND PROMOTE SAVING GASOLINE

(71) Applicants: MAVI YVONNE MACFARLANE, Wauna, WA (US); ELIZABETH LAUREN ASHE, WAUNA, WA (US)

(72) Inventors: MAVI YVONNE MACFARLANE, Wauna, WA (US); ELIZABETH LAUREN ASHE, WAUNA, WA (US)

(21) Appl. No.: 14/140,404

(22) Filed: Dec. 24, 2013

Related U.S. Application Data
(60) Provisional application No. 61/718,705, filed on Oct. 25, 2012.

(51) Int. Cl. G06Q 10/10

(52) U.S. Cl. CPC G06Q 10/1053
USPC 705/321

(57) ABSTRACT

A system that may include a website and linked database may be used to connect people for purposes of job exchange which may result in reducing commutes and promote saving gasoline. The system's database may include people seeking to move closer to home or elsewhere, and the profiles may provide knowledge about occupied jobs unknown to a public job search, or soon to be vacant. Use of the system may result in reduced commute times for users that may improve the problems of traffic congestion, save money on gas and vehicle expenses, reduce wear and tear on highways, save time and add to a better quality of life with family, friends and building community.

### CLAIM OF BENEFIT TO PRIOR APPLICATION

This application claims benefit to U.S. Provisional Patent Application 61/718,705, entitled “System For Exchanging Trip Information To Reduce Driving And Promote Saving Gasoline,” filed Oct. 25, 2012. The U.S. Provisional Patent Application 61/718,705 is incorporated herein by reference.

### BACKGROUND

Embodiments of the invention described in this specification relate generally to mileage saving trip analysis, and more particularly, to job exchanging via network for saving gasoline and mileage commuted.

Commuting for work and driving for many reasons may consume excess gas, time and money. Job-hunting people only know of vacant job positions, made public through a range of websites that may not even be updated timely. As a result, these people may apply to jobs further from their homes then they would like, as well as to job positions which may no longer available. People independently commute to work, sometimes in excess of two hours each way. Gas expense adds up. The driving distance takes away their free-time and disconnects them from forming both a community at work and the community around their homes, friends or families.

Companies only advertise available jobs. Searching for and applying to a job may be a time consuming process and response-time from the company may be slow, if there is any response at all. There are dozens of conventional database job search websites but these sites typically cut-off any direct line of communication between the applicant and the company. These sites typically do not update job status or availability on a timely basis and they typically do not communicate enough criteria of job searches back to the searcher.

Improvements to these conventional databases and services are desirable.

### BRIEF DESCRIPTION

Some embodiments of the invention include a novel system for exchanging jobs and trip information to reduce driving and promote saving gasoline. In some embodiments, a process is performed in the system for facilitating job exchange information between two or more persons. In some embodiments, the process allows a user to search for and exchange job information in order to find a closer job, and thereby reduce travel mileage to and from work.

In some embodiments, the process is a method that is implemented by a software application that operates on a computing device. The method of some embodiments comprises (i) setting up a personal job profile with a level of education and years of work experience in a particular field, (ii) listing the number of miles currently being commuted for work, (iii) identifying other people who work in similar jobs with similar educational background and, if jobs were exchanged between the particular user and another user, would result in a net reduction in commuting mileage, (iv) determining whether the particular user and the other user would like to communicate directly, (v) determining whether both the particular user and the other user wish to exchange jobs, and (vi) informing employers and coordinating a job exchange.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a job exchange process in some embodiments.

FIG. 2 conceptually illustrates a bubble diagram illustrating a plurality of logical groupings of information that may be used to facilitate exchange of job and trip information for a system in some embodiments.

FIG. 3 conceptually illustrates a schematic view of a system that facilitates exchange of job and trip information in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel system for exchanging jobs and trip information to reduce driving and promote saving gasoline. In some embodiments, a process is performed in the system for facilitating job exchange information between two or more persons. In some embodiments, the process allows a user to search for and exchange job information in order to find a closer job, and thereby reduce travel mileage to and from work.

In some embodiments, the process is a method that is implemented by a software application that operates on a computing device. The method of some embodiments comprises (i) setting up a personal job profile with a level of education and years of work experience in a particular field, (ii) listing the number of miles currently being commuted for work, (iii) identifying other people who work in similar jobs with similar educational background and, if jobs were exchanged between the particular user and another user, would result in a net reduction in commuting mileage, (iv) determining whether the particular user and the other user would like to communicate directly, (v) determining whether both the particular user and the other user wish to exchange jobs, and (vi) informing employers and coordinating a job exchange.

As stated above, commuting is one form of a driving trip that may consume excess gas, time and money. The system of the present disclosure may help solve these potential issues relating to commuting. Job hunters only know of vacant job positions, made public through a range of websites that may not even be updated timely. As a result, these job hunters may wind up apply to jobs further from their homes then they would like, as well as to job positions which may no longer available. Many people with jobs wind up independently or individually commuting to work at jobs that are further from their homes than desirable or practical, sometimes in excess of two hours each way. Gas expense for these commutes can be a significant cost for workers traveling excessive distances to reach their jobs. The driving distance and the time required to travel that distance may take away these workers' free-time and may result in these workers being disconnecting and unable to form a community either at work or in the community around their homes, friends or families.

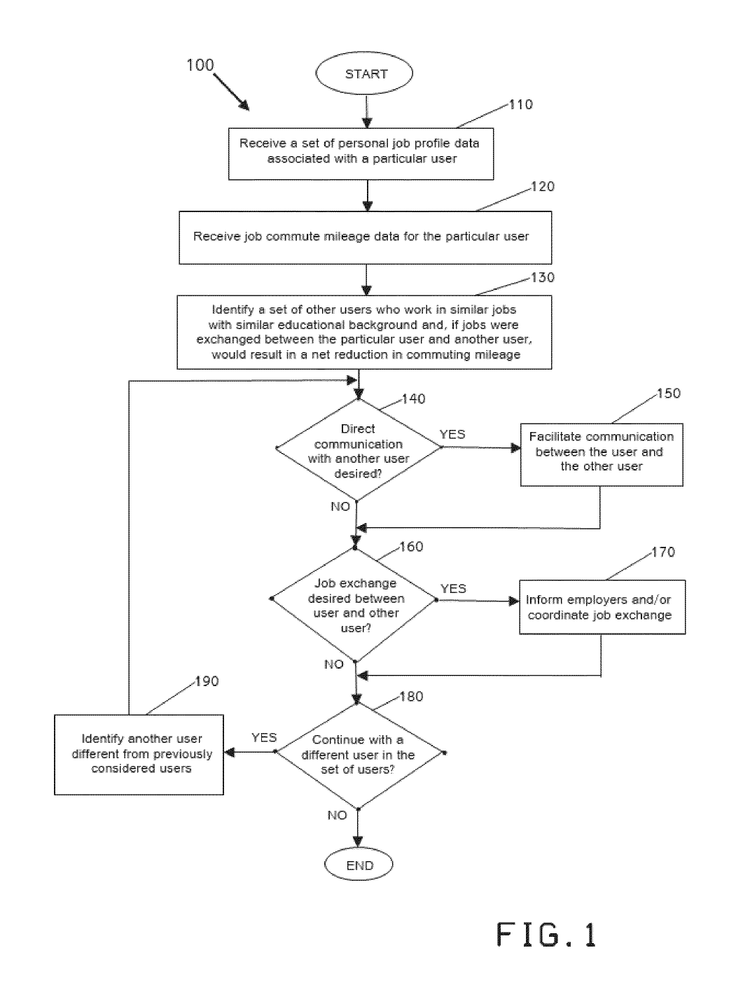

By way of example, FIG. 1 conceptually illustrates a job exchange process in some embodiments. As shown in this figure, the job exchange process 100 starts by receiving (at 110) a set of personal job profile data for the user. The process then receives (at 120) job commute mileage data for the particular user. Next, the job exchange process 100 identifies (at 130) a set of other users who work in similar jobs with similar educational background and, if jobs were exchanged between the particular user and the other user, would result in net reduction in commuting mileage.

In some embodiments, the process 100 proceeds to the next step to determine (at 140) whether direct communication with another user is desired. If not, the process 100 transitions to the next stage, which is described in further detail below. On the other hand, if the process determines that direct communication is desired, then the process facilitates (at 150) communication between the user and the other user. The process then transitions to the next stage, to determine (at 160) whether a job exchange is desired. In some embodiments, when job exchange is wanted, the process 100 informs (at 170) employers the process 100 transitions back to 180, to determine (at 180) whether to continue with a different user. Then at 190, the process identifies (at 190) another user different from previously considered users.

In some embodiments, the job exchange and trip information system solves such problems by leveraging information from a database of profiles of people seeking to move to jobs closer to home or elsewhere. These profiles include information about occupied jobs unknown or unavailable to anyone conducting a public job search. In some embodiments, the profiles include job information for jobs that are soon to be vacant. By aiding people in finding jobs closer to home and shifting to jobs closer to home, the job exchange and trip information system of some embodiments reduces commute time and aids in improving traffic congestion, thereby saving money on gas and vehicle expenses, reducing wear and tear on highways, saving time, and adding to a better quality of life with family, friends, and community.

With the system of some embodiments, people register their current jobs and/or search for new jobs, with an intent to exchange jobs with someone in a closer commute radius to work or new desired location. Information for a user profile provided at registration may include the registrant's experience profile and current job description. The database of the system of the present disclosure may offer a single source for a confidential search and exchange of information, which may in result in a simpler to access source of information. This may in turn open relocation possibilities for currently employed workers and may provide a comprehensive job description (with possibly enhanced information about specific location), and may provide a secure channel of communication for job searchers. Preferably, information about a job in the database could only be accessed by a searcher whose profile indicates that the job would be within a radius of their preferred area and with a like-kind job or experience. The system of the present disclosure may preferably be operated with software coding that will be designed to connect people directly to each other with e-alerts or similar specialized reporting tools indicating that one or more potential connection are in the database. These alerts or messages could be sent to a smart phone, to an e-mail account, or sort of suitable secure communications medium.

In some embodiments, the system implements a set of active job posting algorithms that provide the ability to post and view live job opportunities. In some embodiments, the live job postings are implemented in a web site that includes one or more web pages on which live job postings are made possible in combination with one or more other aspects of job exchanges.

Job exchanges made possible or identified in the system in some embodiments include more than two parties; on a separate link in a web page within the system, an option to provide for companies to post vacancies or possible transfer opportunities. Thus, the employer as well as the employee and the job searcher may be actively involved in the seeking of a transfer situation. The system in some embodiments further provides a place to post imminent job openings. For example, if someone was thinking about retiring, quitting, or getting a job elsewhere, these soon-to-occur vacancies could be posted before it would normally be available for discovery by job searchers.

Approximately 10,000 people retire daily in America. The database system of the present disclosure may have a section for soon-to-be-created vacancies created by these retirees so the members can connect or capture these jobs and locations, potentially reducing cost for employers and helping to create a smoother continuation of work for the company.

In some embodiments, the database and system provide a single hub or information exchange center for anyone looking for a potential job exchange, according to a specific area and like-kind job. Through the system, people will be able to exchange information confidentially. The system of some embodiments provides a discreet way to search jobs while protecting current employment status. The system in some embodiments permits users and employees to communicate with others about employers, fellow workers, job environment, etc., before deciding to take the next step to exchange jobs. Response times from future employers could be improved by making a connection between the potential employee and the employer much more direct, due to the job exchange and due to the pre-qualifications proven by the job-exchange connection. During the search, employees may worry that their current employer will discover they are looking to move jobs, which may result in the employee being discharged preemptively

The job exchange possibilities presented by the system of the present disclosure may also serve to reduce traffic in other ways for workers who do not wish to change or exchange jobs

Currently, carpool options are vastly underutilized and unpublicized. The system of some embodiments is able to assist and improve connectivity of carpool member networks and potential carpool users through a separate page in the database for carpools. Also, many people currently prefer to drive to work on their own, even with long commutes congesting highways. These people may not be suitable candidates for carpools and public transportation. Further, it should be noted that carpools do not necessarily increase personal time away from work and they do not shorten the length of commute time.

The database of the system in some embodiments includes profile information relating to people seeking to move to jobs that are closer to home or to a specific location. These profiles may provide knowledge about occupied jobs unknown to a public job search, or soon-to-be-vacant jobs. While the nature of the database in some embodiments of the system is a locality specific database, in some other embodiments, the database used in the system is a broad region database. For instance, a broad region database may include a set of replicated database for different/overlapping regions or a plurality of adjacent regions. In some embodiments, the database is accessed by software created to operate the database in one geographic area. In some other embodiments, the database may be replicated and the software may access replicated databases in different geographical regions.

In some embodiments, specific occupational specialties are segregated within the database and/or specific labor sectors are isolated as well. For example, some non-limiting examples of segregating employment areas may include, but not be limited to, government employment, various medical fields and school or higher education systems. When the software is replicated for use in different geographic areas or in different vocational areas or industries, in some embodiments, the various incidences of the software may be linked for data aggregation and reporting purposes. These aggregated data may be used to illustrate an overall impact of the use of the information exchange in reducing passenger-miles spent in commuting as well as the number of person-hours saved as a result of reducing commuting time that can now be put to more productive use

A separate link or segregated area may be included within the scope of the present disclosure that is focused on providing information for truckers. While there are systems currently that permit drivers within the same company to find loads to avoid an unladened or dead-head trip, there is not currently a system or service that permits truckers to search and find possible loads regardless of who the trucker may work for. The system of the present disclosure may be adapted for use by trucking and shipping companies to help avoid shipping goods one direction while another company ships similar products in the opposite direction, near them. This potential reduction in crossover may save gas, increase salaries, reduce traffic and wear to roads.

In some embodiments, the system includes the following elements. This list of possible constituent elements is intended to be exemplary only and it is not intended that this list be used to limit the system to just these elements. Persons having ordinary skill in the art relevant to the present disclosure may understand there to be equivalent elements that may be substituted within the present disclosure without changing the essential function or operation of the job exchange and trip information system.

1. A website and database to connect people to exchange jobs. Preferably, one hub would be built which will connect a member to database-generated connections for potential job exchange. Each person who registers receives their own membership account for saved connections, e-mails and job profile.

2. Specialized coding in the software of the system to connect people and to protect their privacy between each other confidentially. The coding process may be the backbone for the profiles and enable users to search a radius location chosen by a member. This will aid in connecting the dots with other people in different places, over jobs they would not otherwise be able to find.

3. A link to create job applications for local companies. If a member wants to move further away, there will be a list of profile member recommended companies to work for and links to apply. Companies may advertise all of their opportunities, but their focus is not limited to local opportunities. A link to local opportunities within a company further enhances the understanding and reach of a particular local job search.

4. A link for people retiring, to create transition with a new employee. This area is similar to job applications for local companies; positions available due to retirement have a different time-frame than exchange jobs or currently vacant jobs. There are multiple advantages to this link:
A. The retiree may find a person to replace a job they have held for an extended period of time and wish to fill with an appropriate person for the particular job they respect.
B. A person in search for work in a stable company that would not had otherwise been able to discover in advance, since it was not publicly advertised yet. This advanced time frame and acquaintance to the retiree gives advantage to the applicant going-in, as well as to the employer, who will need to devote fewer resources to fill the job.

5. A link to open up the communication between trucking companies to reduce crossover on their deliveries. The link may open a separate website and database for the trucking transportation industry. When trucks can check their routes and cargo against cargoes and routes of other trucking companies, they may be able to streamline deliveries and increase profit margins.

6. Multiple links and coding to connect to the major social networks and allow people to find the service through existing familiar pathways. Access to major social networking sites will help by furthering the advertising reach of profiles.

7. A gas counter is to document ongoing savings of gas based on reported exchanges information, to highlight the benefit of system of the present disclosure for the country or a specific region. A counter of miles and/or hours saved cumulatively to document the miles or time saved by individuals in their commute to work. A cumulative count may be based on the miles each system user saves as a result of changing from their old job to a new job location. The savings may be equated to more free time before and after work. The purpose of this element is to help people find the system of the present disclosure, and thus use the services more efficiently and save time and resources, and possibly calculate gas amounts to be saved, in advance of a job exchange.

8. A forum not dependent on profile membership, where it will preferably allow for discussion of such topics as carpools, career tips and products to reduce gas usage or help the environment. It will preferably allow people to discuss such things as, but not limited to, forming potential carpool groups, warning about major road construction delays and discussing eco-friendly products and services.

9. A counter of miles saved cumulatively, to indicate how the exchange has resulted in an anticipated reduction in overall annual miles.

10. Rights management and privacy guard including one or more website links to preserve privacy or public openness.

11. A social media link to post, review, communicate, and otherwise connect to social media. For instance, links to social network websites focused on careers may be included.

12. Live job postings on one or more web pages. These live job opportunities are available in some embodiments for employers, employees, or others to post, and for employees and other job exchange seekers to review.

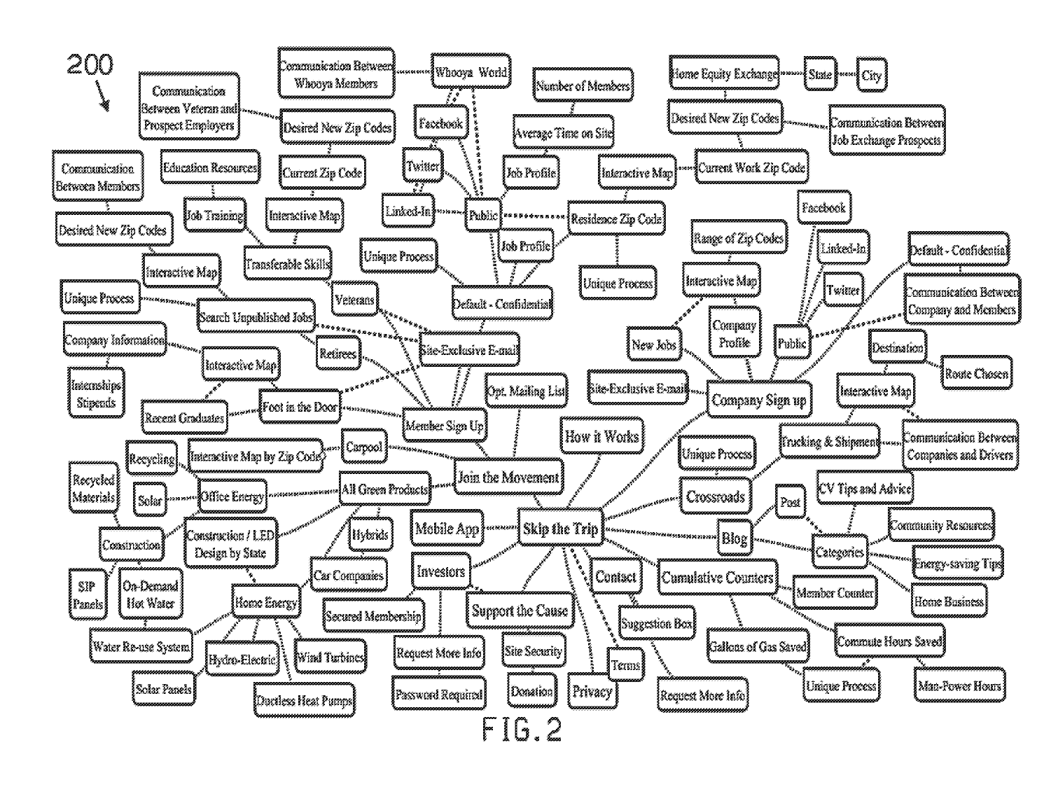

The various elements of the system in some embodiments are related in the following exemplary fashion. It is not intended to limit the scope or nature of the relationships between the various elements and the following examples are presented as illustrative examples only. In FIG. 2, a bubble diagram is conceptually illustrated with several logical groupings of information that may be used to facilitate exchange of job and trip information in some embodiments.

In some embodiments, relationships between different profiles forms the logical groupings. For instance, the logical groupings may include different groupings for different web pages or resources of a website. Also, developing links to other large database or social networking sites will assist people finding and utilizing the site to help grow faster.

To build the system of some embodiments, system architects and/or systems engineers may design the components and each step in the process to be specifically coded for multiple applications, interconnecting each link in the designed web pages, separating confidential pages along with open communication pages, chosen by the user. An interactive radius map may be included as an initial component in starting a job search. An interactive radius map will assist in creating a search-for-exchange. The ability to connect with geographic locations and people directly, via profile accounts with private e-mail/smart phone communications to ensure individual control, is also highly desirable. The user may be able to come to the system of the present disclosure and search private jobs/exchanges in a given area. There may be licensing agreements with large job sites with publicly listed job offerings in a specific area. The system may facilitate private connections to provide a unique way to find jobs otherwise publicly unavailable. In addition, users may publish their jobs if they are retiring or moving jobs. In any job listing, it is anticipated that the system may include links to the employing companies to apply online once a job is chosen privately or openly and communication has been started with an employer. To ensure accuracy and privacy, it is anticipated that there may be requirements for permission to be agreed to regarding the information to be exchanged or saved at each step. It is also anticipated that common or universal job application pages may be created for use by a single large employer or which may be common between several companies. Components such as a cumulative time/gas/mileage saved counter may be derived from information input after an exchange is complete. Plus, the system may be optimized and customized to provide directed advertising to make people aware of the cumulative impact of the system as well as other ways to save money and help the environment e.g. advertising green products and companies.

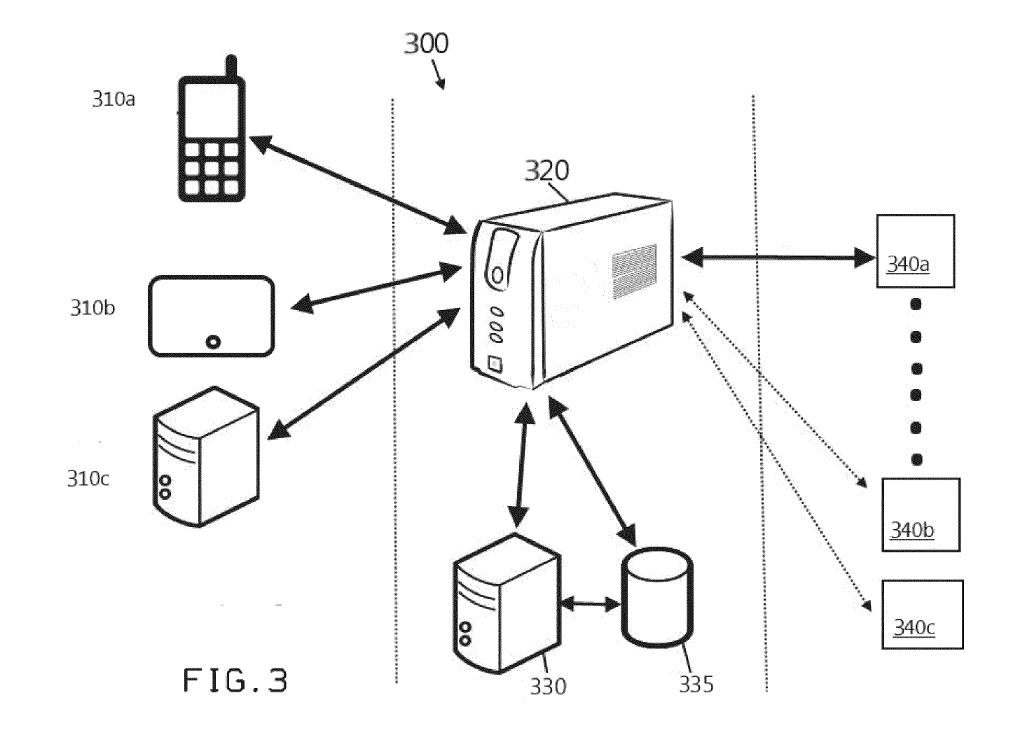

By way of example, FIG. 3 conceptually illustrates a schematic view of a system that facilitates exchange of job and trip information in some embodiments. As shown, a set of client computing devices, 310a, 310b, and 310c connect over a network to the server computing device 320. The server 320 may be connected directly to a database storage file 335 or in some embodiments, to a database server 330. One or more employer computing devices (i.e., 340a, 340b, and 340c).

In some embodiments, a process is performed in the system. In some embodiments, the process is implemented as a software application that operates on a processor of a computing device in the system. For instance, the process may be operating on the server 320 computing device, while in communication (over the network) with one or more client computing devices (310a-310c), a database management system operating on a database server 330 connected to a database 335, and updating employer computing device 340a, 340b, and 340c. In some embodiments, the software application performs the following steps:

1. Receive a set of personal job profile data associated with a particular user (i.e., when a user attempts to set up a personal job profile with level of education and/or years of their specific experience in a particular field).

2. Receive job commute mileage data for the particular user (i.e., list the number of miles they currently commute to their job), number of years on the particular job, and/or one or more locations they would desire to work, in the particular city or in other states.

3. Identify a set of other users who work in similar jobs with similar educational background and, if jobs were exchanged between the particular user and another user, would result in a net reduction in commuting mileage

4. Determine whether the particular user and the other user would like to communicate directly, and if so, facilitate the communication (i.e., chat session, video conference, etc.) between the particular user and the other user

5. The user may receive many different jobs and/or locations to choose from. The profiler could choose multiple connections and geographic location parameters, locally or in other states if they would like to make a larger move

6. Determine whether both the particular user and the other user wish to exchange jobs, and inform employers/coordinate job exchange

The user may receive many different jobs and/or locations to choose from. The profiler could choose multiple connections and geographic location parameters, locally or in other states if they would like to make a larger move.

Additionally, the software may be licensed or otherwise able to be used or linked by other companies such as Facebook, Twitter, Linkedin, as a way for people to find the service. The software can be further created, licensed and sold at a later time to other countries, entities or businesses around the world.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

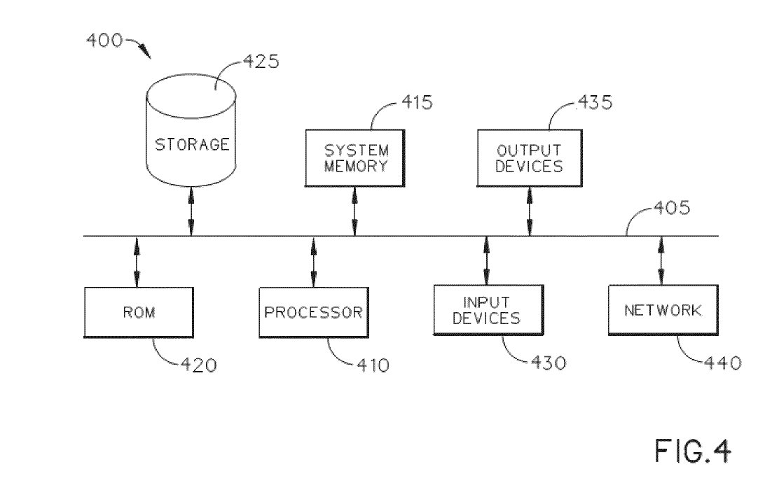

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an Intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process is conceptually illustrated in FIG. 1. The specific operations of this process may not be performed in the exact order shown and described. Specific operations may not be performed in one continuous series of operations, and different specific operations may be performed in different embodiments. Furthermore, the process could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A non-transitory computer readable medium storing a program which when executed by at least one processing unit of a computing device provides a job exchange system for a plurality of users to connect, exchange job information, and exchange jobs, said program comprising sets of instructions for:
receiving a set of personal job profile data associated with a particular user;
receiving job commute mileage data for the particular user;
identifying a set of other users who work in similar jobs with similar educational background and, if jobs were exchanged between the particular user and another user, would result in a net reduction in commuting mileage; and
determining whether the particular user and the other user would like to communicate directly;
when both the particular user and the other user would like to communicate directly, facilitating communication between the particular user and the other user;
determining whether both the particular user and the other user wish to exchange jobs; and
when the particular user and the other user both wish to exchange jobs, informing employers of the interest and coordinating the job exchange.

2. A system for gathering and distributing job and employee's information, the system comprising:
a database containing information regarding a plurality of employed users, the users being employed persons who are providing information regarding themselves and their current jobs, the information regarding each of these users including specific information regarding the skills, training and experience of the employed user and a desired geographic location where the employed user is seeking a new job, the information regarding their current jobs including necessary skills and geographic location, the database further including information regarding whether the employed user wishes to exchange jobs or is planning to leave or retire from their current job;
the database further containing information regarding a plurality of users looking for a new job without listing their current job, if any, the information regarding these users looking for a new job including specific information regarding the skills, training and experience of the user and a desired geographic area where the user is seeking a new job;
the database further containing information regarding a plurality of job openings, including necessary skills for the job and a geographic location of the job;
software configured to compare the jobs listed in the information regarding the plurality of employed users and the plurality of job openings with the skills, training and experience of the employed users and users, as well as the desired geographic locations where the employed users and users are seeking new jobs; and
providing information to the employed users and users regarding opportunities that are within their desired geographic area and facilitating employed users and users in finding or exchanging employment in their desired geographic area to reduce commute time and distance.
